(19) United States
(12) Patent Application Publication
(10) Pub. No.: US 2018/0075566 A1
(43) Pub. Date: Mar. 15, 2018

(54) SYSTEM AND METHOD OF CALCULATING A PRICE FOR A VEHICLE JOURNEY

(71) Applicant: Addison Lee Limited, London (GB)

(72) Inventor: Paul Lacey, Ashtead (GB)

(21) Appl. No.: 15/553,166

(22) PCT Filed: Feb. 24, 2016
(86) PCT No.: PCT/IB2016/051010

§ 371 Date: Aug. 23, 2017

(30) Foreign Application Priority Data
Feb. 24, 2015 (GB) 1503081.0

(51) Int. Cl. G06Q 50/30; G06Q 10/02

(52) U.S. Cl. CPC G06Q 50/30; G06Q 10/02

(57) ABSTRACT

A System and Method of Calculating a Price for a Vehicle Journey A system and method for calculating a price for a vehicle journey are provided, the method performed at a vehicle management server. The vehicle management server receives a journey booking comprising journey information, the journey information specifying at least a start time, a start location and an end location. The journey information may also specify further information. A journey cost calculation module, which may be integral with or separate from the vehicle management server, calculates a base price for the journey based on the start and end points of the journey. The journey cost calculation module checks whether the start time of the journey booking is within a predetermined time period specified by a first modifier rule and if the start time of the journey booking is within the predetermined time period, applies a price adjustment to the calculated base price according to the first modifier rule.

### FIELD OF THE INVENTION

The present invention relates to the calculation and modification of travel fares, in particular to the advanced modification of private hire car fares according to a range of different criteria.

### BACKGROUND OF THE INVENTION

In the field of private hire cars, a customer will typically call a central booking centre when they wish to book a taxi. The customer is then quoted a price for their journey. However, at the time of the journey the conditions may be different from when the booking was made, resulting in the quoted price no longer being appropriate. This can result in a change in the fare, in which case the customer is charged an amount that they were not expecting. In some other instances, particular customers may have an agreement with the private hire firm to be charged a certain amount for a certain journey. However, this information must generally be entered manually or remembered by the controller or driver.

### SUMMARY OF THE INVENTION

A first aspect f the invention provides a method of calculating a price for a vehicle journey, the method comprising:
a vehicle management server receiving a journey booking comprising journey information, the journey information specifying at least a start time, a start location and an end location;
a journey cost calculation module calculating a base price for the journey based on the start and end points of the journey;
the journey cost calculation module checking whether the start time of the journey booking is within a predetermined time period specified by a first modifier rule; and
if the start time of the journey booking is within the predetermined time period, applying a price adjustment to the calculated base price according to the first modifier rule.

The method may further comprise the journey cost calculation module:
checking whether the start location and/or end location of the journey are within a predetermined region specified by the first modifier rule; and
if the start location and/or end location of the journey are within the predetermined region, applying the price adjustment to the calculated base price according to the first modifier rule.

The predetermined region may be a predefined region of a city. The predetermined region may be defined by a predefined proximity to a public event.

The journey information may specify a payment type for the booking and the method may further comprise the journey cost calculation module:
checking whether the payment type specified in the journey information meets a payment type condition specified by the first modifier rule; and
if the payment type meets the payment type condition, applying the price adjustment to the calculated base price according to the first modifier rule.

The journey information may specify a total journey distance for the booking and the method may further comprise the journey cost calculation module:
checking whether the total journey distance specified in the journey information meets a total journey distance condition specified by the first modifier rule; and
if the total journey distance meets the total journey distance condition, applying the price adjustment to the calculated base price according to the first modifier rule.

The journey information may specify a customer account for the booking and the method may further comprise the journey cost calculation module:
checking whether the customer account specified in the journey information meets a customer account condition specified by the first modifier rule; and
if the customer account meets the customer account condition, applying the price adjustment to the calculated base price according to the first modifier rule.

The price adjustment may comprise one or more percentage adjustments. Alternatively, or in addition, the price adjustment may comprise or more fixed amount adjustments. Alternatively, or in addition, the price adjustment may comprise one or more unit amount adjustments, wherein the base price for the journey is dependent on the unit amount multiplied by a price per unit value.

The method may further comprise the journey cost calculation module searching a price modifiers database for further modifier rules which are applicable to the received journey booking. Each modifier rule stored in the price modifiers database may have an associated sequence order number and the method may further comprise the journey cost calculation module checking the modifier rules stored in the price modifiers database against the journey information in sequence order.

A second aspect of the invention provides a computer program comprising instructions that when executed by computer apparatus control it to perform the method of the first aspect of the invention.

A third aspect of the invention provides a system for calculating a price for a vehicle journey, the system comprising a vehicle management server and a journey cost calculation module, wherein:
the vehicle management server is configured to receive a journey booking comprising journey information, the journey information specifying at least a start time, a start location and an end location; and
the journey cost calculation module is configured to:
   calculate a base price for the journey based on the start and end points of the journey;
   check whether the start time of the journey booking is within a predetermined time period specified by a first modifier rule; and
   if the start time of the journey booking is within the predetermined time period, apply a price adjustment to the calculated base price according to the first modifier rule.

The journey cost calculation module may be further configured to:
check whether the start location and/or end location of the journey are within a predetermined region specified by the first modifier rule; and
if the start location and/or end location of the journey are within the predetermined region, apply the price adjustment to the calculated base price according to the first modifier rule.

The predetermined region may be a predefined region of a city. The predetermined region may be defined by a predefined proximity to a public event.

The journey information may specify a payment type for the booking and the journey cost calculation module may be further configured to:
check whether the payment type specified in the journey information meets a payment type condition specified by the first modifier rule; and
if the payment type meets the payment type condition, apply the price adjustment to the calculated base price according to the first modifier rule.

The journey information may specify a total journey distance for the booking and the journey cost calculation module may be further configured to:
check whether the total journey distance specified in the journey information meets a total journey distance condition specified by the first modifier rule; and
if the total journey distance meets the total journey distance condition, apply the price adjustment to the calculated base price according to the first modifier rule.

The journey information may specify a customer account for the booking and the journey cost calculation module may be further configured to:
check whether the customer account specified in the journey information meets a customer account condition specified by the first modifier rule; and
if the customer account meets the customer account condition, apply the price adjustment to the calculated base price according to the first modifier rule.

A fourth aspect of the invention provides a non-transitory computer-readable storage medium having stored thereon computer-readable code, which, when executed by computing apparatus, causes the computing apparatus to:
receive a journey booking comprising journey information, the journey information specifying at least a start time, a start location and an end location;
calculate a base price for the journey based on the start and end points of the journey;
check whether the start time of the journey booking is within a predetermined time period specified by a first modifier rule; and
if the start time of the journey booking is within the predetermined time period, apply a price adjustment to the calculated base price according to the first modifier rule.

A fifth aspect of the invention provides an apparatus comprising at least one processor and at least one memory including computer program code, the at least one memory and the computer program code configured to, with the processor, cause the apparatus to at least:
receive a journey booking comprising journey information, the journey information specifying at least a start time, a start location and an end location;
calculate a base price for the journey based on the start and end points of the journey;
check whether the start time of the journey booking is within a predetermined time period specified by a first modifier rule; and
if the start time of the journey booking is within the predetermined time period, apply a price adjustment to the calculated base price according to the first modifier rule.

### BRIEF DESCRIPTION OF THE FIGURES

FIG. 1a is a schematic diagram of a system for management of a private hire vehicle service according to various aspects of the present invention;

FIG. 1b is a schematic diagram of a different configuration of the FIG. 1 system for management of a private hire vehicle service according to various aspects of the present invention;

FIG. 2 is a flow chart illustrating overall operation of the system in fulfilling a booking through providing a private hire vehicle, and is performed by the system of FIG. 1a or the system of FIG. 1b;

FIG. 3 is a flow chart illustrating calculating a score for a combination of a vehicle/driver pair in relation to a booking, and is performed by the system of FIG. 1a or the system of FIG. 1b;

FIG. 4 is a flow chart illustrating allocation of a vehicle/driver pairing in relation to a booking, and is performed by the system of FIG. 1a or the system of FIG. 1b;

FIG. 5 is a schematic diagram illustrating components of a server forming part of the FIG. 1a or FIG. 1b system;

FIG. 6 is a screenshot of a tariff modification editor which can be used to create a modified pricing scheme according to the present invention;

FIG. 7 is a flow chart illustrating exemplary operation of some embodiments of the invention;

FIG. 8 is a flow chart illustrating further exemplary operation of some embodiments of the invention.

### DETAILED DESCRIPTION OF SOME EMBODIMENTS OF THE INVENTION

Embodiments of this invention relate to the modification of the price calculation algorithm performed by the journey cost calculation module 122. The price for any particular journey may be modified according to a number of different criteria, so that an accurate price is returned to the customer at the time the booking is made. A customer can make a booking electronically through a web portal or application as will be described below. An accurate price for the journey (even if the journey is some time in the future) is quickly returned to the customer. This is made possible by the data stored in the map and location database 109, address database 115, accounts database 119 and journeys travelled database 108 and the immediate access that the journey cost calculation module 122 has to these databases due to the interconnectivity of the system 100.

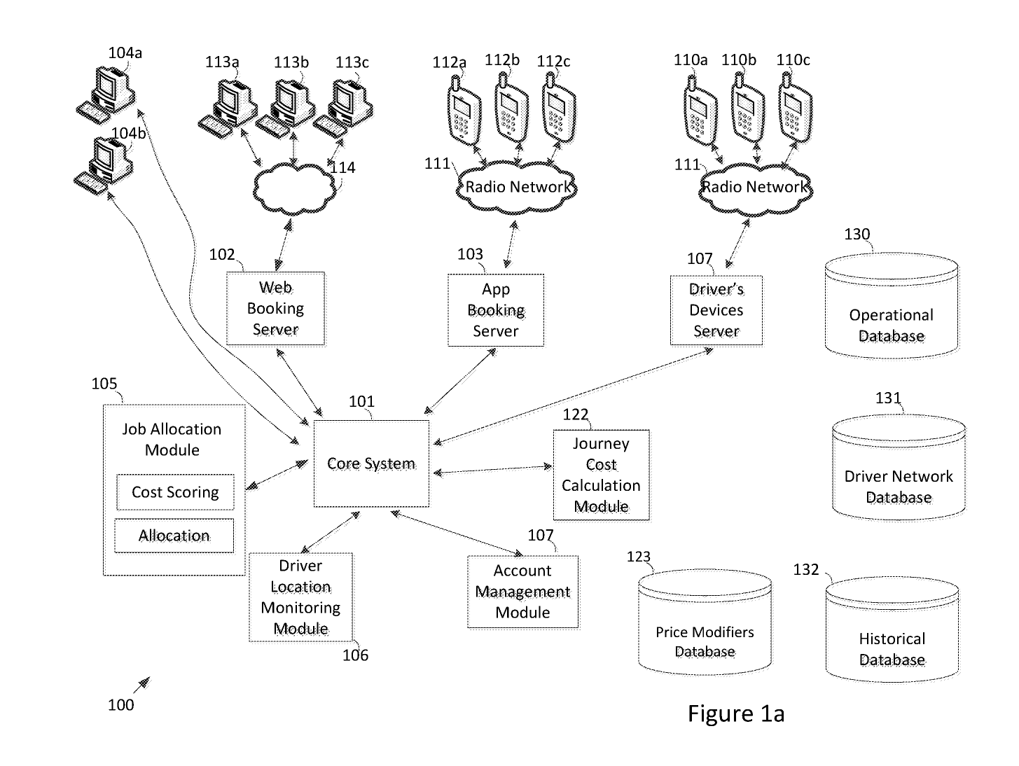

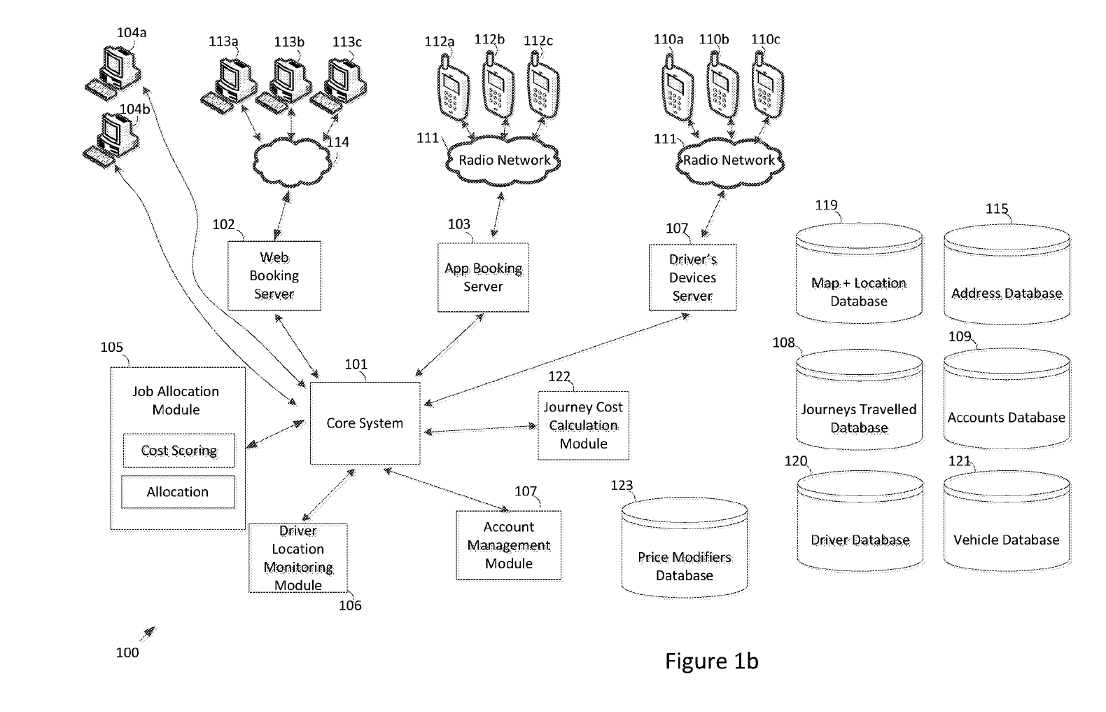

FIG. 1a is a schematic diagram of a system for management of a private hire vehicle service according to various aspects of the present invention.

The system 100 includes a number of interconnected components, as will now be described. The system 100 includes at its centre a core system 101. This comprises one or more server computers running system software that ensures smooth operation of the system 100.

Key functions of the system 100 are bookings, allocation of a private hire vehicle to a booking, vehicle and driver management, account management and record keeping.

The booking function is provided primarily by a web booking server 102, an application booking server 103 and call centre terminals 104A and 104B, all of which are coupled to the core system 101.

The allocation function is provided primarily by a job allocation module 105, with information from other parts of the system 100.

The system includes database functions. In particular, an operational database 130 stores records that relate to general operation of the system 100. A driver network database 131 stores records that relate to drivers and vehicles that are managed by the system 100. Lastly, a historical database 132 stores records that have been archived from the operational database 130. Archiving of records from the operational database 130 to the historical database 132 occurs periodically and only records that are no longer needed for general operational use are archived.

The vehicle and driver management function is provided primarily by a driver location monitoring module 106 and a driver's devices server 107, with reference to the driver network database 131 as well as other components of the system 100.

The account management function is provided primarily by an account management module 117, utilising accounts information stored in the operational database 130 along with other components of the system 100.

The operational database 130 stores details of every account held with the operator of the system 100. Each account is identified by an account number stored in the operational database 130. The accounts information stored in the operational database 130 may also include an account name, such as a company name and contact details for the company. The accounts information stored in the operational database 130 stores credit card details and/or other payment details so that payment can be taken from the account holder if permitted. A password and/or PIN (personal identification number) is associated with each account and stored with the accounts information in the operational database 130. Furthermore, a list of persons authorised to make bookings on the account may be stored, and optionally profiles for the individual authorised persons within the accounts.

The accounts information stored in the operational database 130 may also include a contact name and telephone number of a person who should be contacted in case of problems with the account. The accounts information stored in the operational database 130 includes information regarding invoicing preferences, for example the frequency of invoicing, date on which the invoice should be sent, the monthly/weekly credit limit and what information from each booking should be included on the invoice. The accounts information stored in the operational database 130 may indicate whether each account is active, or if it has been placed on hold. An account may be placed on hold by a credit control department and this may prevent further bookings being made on the account. Historical data of spending on the account may also be stored in the operational database 130, or this may be stored in the historical database 132.

The record keeping function is provided primarily by the historical database 132, although the operational database 130 and the driver network database 131 also provide some record keeping function.

In brief, a fleet of private hire vehicles is managed by the system 100. Each vehicle has a respective record in the driver network database 131, as will now be described.

The driver network database 131 stores information about every vehicle in the fleet. The registration number (license plate number) of each vehicle is stored in the driver network database 131. This may be used to identify each vehicle. Alternatively or in addition, a unique identifier separate from the registration number may be assigned to each vehicle as the primary means of identification within the driver network database 131.

Each Service is defined according to its vehicle type, capacity and other characteristics. In some embodiments, these types are “Up to 4 passengers”, “Up to 7 passengers”, “Electric vehicle”, “VIP” and “Up to 4 passengers with luggage”. The driver network database 131 stores the type of each vehicle and may also store a corresponding number or short string of characters which represents each type. Any special equipment such as a baby seat or the ability to accommodate a wheelchair is also identified in the driver network database 131. The driver network database 131 indicates the current driver to whom the car is assigned, although the driver/vehicle allocation changes from time to time.

The driver network database 131 stores the make and model and optionally the colour of each vehicle. The driver network database 131 also indicates the current status of the vehicle. In some embodiments, the status is chosen from “Driver Pool”, meaning that the car is in use by a driver, “Free Pool”, meaning that the car is not currently being used and is free to be allocated to a driver and “Workshop”, meaning that the car is undergoing maintenance or repair. The driver network database 131 also stores the private hire license number (PCO) for each vehicle and the date on which this license expires as well as the road tax, vehicle insurance and MOT (vehicle roadworthiness certificate) expiry dates if appropriate. Examples of other data which may be stored are the date of purchase of the vehicle, the price paid for the vehicle, the date of manufacture, the supplier of the vehicle, warranty information and the date of the last inspection/maintenance.

Historic data about each vehicle may also be stored in the driver network database 131, such as a record of the previous registration numbers and a record of the previous drivers who were assigned to the vehicle. The service history and details of any accidents and repairs may also be stored.

The fleet of private hire vehicles is driven by a pool of drivers, each of which has a record in the driver network database 131.

The driver network database 131 stores information about each of the drivers registered with the operator of the system 100. The information relating to drivers includes personal data such as name, contact details (including phone number, home address), date of birth, next of kin and driver account data. Driver status information may be stored to indicate whether a driver is active or inactive, whether the driver has been allocated a vehicle etc. Each driver may also be assigned an individual and unique identifier as a means of identifying the driver. Callsigns may also be used to denote drivers and are stored in the driver network database 131, although callsigns can be changed and reallocated between drivers as long as the same callsign is not in use by two drivers at the same time.

Driver account data includes an account number. Other information may include a driver's insurance details, a driver's length of service in the fleet, details of parking fines, historical wage information, holiday leave, driver diary information, information regarding payment collections from drivers, driver's license number, national insurance (social security) number, details relating to a driver's taxicab license (such as Public Carriage Office (PCO) license), driver banking details (account number, sort code etc.). Miscellaneous information such as details of any allergies, smoker/non-smoker etc. may also be stored in the driver network database 131. Information regarding driver equipment such as a serial number of the driver's device 110 allocated to the driver, and mobile phone number of their driver's device 110 and their private mobile phone may also be recorded. Statistical information such as date of last job or historical earnings data may be recorded in the driver network database 131, or this may be recorded in the historical database 132.

Information relating to payments to and from drivers may be stored in the driver network database 131. Payments to the driver include a driver's wages. Driver outgoings may include, for example, car wash charges, insurance premiums, PCO renewal fee, accident costs, vehicle rental. To assist in maintaining this information, a purchase ledger number and contract number relating to each driver may be stored. Each driver has an associated driver's device 110, three of which are shown at 110A, 110B and 110C in the Figure. The driver's devices 110 are portable electronic devices that are provided with wireless communication facilities. The driver's devices 110 may take any suitable form, but typically are smart phones or personal digital assistants or such like. The driver's devices 110 include a display and one or more input devices such as a keyboard, a voice control module or a touch screen or any combination thereof.

The driver's devices 110 are connected to the driver's devices server 107 via radio network 111, which may for instance be a mobile phone (cellular phone) network. In this case, the driver's devices 110 are provided with subscriptions to the mobile phone network such that they can send digital data to and from the driver's devices server 107. Additionally, messages are able to be passed between the driver's devices 110 and the driver's devices server 107 through other media, and in particular SMS (short message service) messages and optionally also MMS (multimedia message service) messages.

The radio network 111 may alternatively be a dedicated radio network, for instance a private mobile phone network or a private radio network of some other type.

Data may be communicated between the driver's devices 110 and driver's devices server 107 over any suitable communications link, for instance using a data channel of a cellular telephone network such as a GSM, EDGE, GPRS, UMTS, HSxPA or LTE network.

The driver's devices 110 are configured to report their locations to the driver network database 131 at regular intervals, for instance 30 second intervals. The driver's devices 110 include GPS (global positioning system) receivers, which calculate the locations of the driver's devices 110 under control of the software applications executing on the driver's devices 110. Alternatively, they may include some other positioning module or device that is operable to calculate the positions of the driver's devices 110 with a suitable level of accuracy and resolution.

A private hire vehicle may be booked by a customer in one of three ways. Firstly, a private hire vehicle may be booked in a telephone conversation with a call centre operator. In this case, the customer initiates a telephone call with a call centre, an agent of which operates one of the call centre computer terminals 104A and 104B. The call centre agent then operates the terminal 104A, 104B so as to make the booking of the private hire vehicle according to the customer's requirements. The customer's requirements are obtained verbally during the telephone conversation between the customer and the agent.

In the second option, the customer may make the private hire vehicle booking using a browser application on a computing device 113, three examples of which are shown at 113A, 113B and 113C in the Figure. Each of the computing devices 113 is connected to the web booking server 102 by a network 114, which may for instance be the Internet or to another public or private network. The web booking server 102 includes web server functionality that causes display of suitable web pages by the browser of the terminal 113. The customer's requirements with respect to the private hire vehicle booking are obtained by the web booking server 102 through the provision of suitable pages to the computer terminal 113 requesting the provision of the required information by the customer. The information may be provided by the customer through free text entry through the use of drop down lists, radio buttons etc. Some information may be pre-filled into the web pages provided by the web booking server 102.

Booking through the web booking server 102 may require the customer to login to a web portal before they can make their booking. The logging in may require the entering of a username and a password or PIN number. Through the control of a web session by the web booking server 102, for instance using cookies provided to the computer terminals 113, the booking can be known to have been validly made by virtue of the customer having being logged in to the web booking server at the time the booking was made.

The final way in which a customer can make a booking of a private hire vehicle is using a dedicated software application that is installed on and running on a portable communications device 112, three of which are shown at 112A, 112B and 112C in FIG. 1a. The portable communications devices 112 may take any suitable form, but typically are smart phones, feature phones, tablet computers or personal digital assistants or such like. The communication devices 112 are coupled to the application booking server 103 by a radio network 111, which may be the same as the radio network 111 described above with relation to the driver's devices 110 and the driver's devices 107. The application is configured to provide a user interface that allows the customer to provide the software application with the information required to make the private hire vehicle booking. For instance, the software application, when executed, may cause the display of interactive pages that allow the customer to select or enter the required information. The software application is configured also to communicate the information relating to the booking that has been provided by the customer to the application booking server 103. If based on information provided by the customer it is determined that the application booking server 103 requires additional information, the software application running the mobile device 112 is configured to provide an interactive display to the customer such that the customer can provide the information, following which the software application causes it to be provided to the application booking server 103.

The customer may be required to log in to the software application on the mobile device 112, prior to making a booking. Logging in to the software application may require a username and a password or PIN number. Alternatively, the username may be entered during set up of the application and may not need to be entered subsequently when this software application is executed. If the username is not required to be entered, the user may log in to the software application simply by entering the password or PIN number.

The information about the private hire vehicle booking that is obtained during the booking process is as follows.
Customer details. The customer details may be the name of the customer or an identifier that uniquely identifies the customer within the operational database 130.
Service type. This indicates the category of vehicle. For instance, the service type may indicate a vehicle of a standard type and having four seats, or a vehicle of a standard type and having seven seats. The service may alternatively indicate a VIP vehicle, or an environmentally-friendly (electric or hybrid) vehicle (also known as a green vehicle).
Journey type. The journey type may be a single (one-way) trip, or it may be a wait and return trip. The journey type may alternatively be a journey including multiple pick-up locations or multiple drop off locations or both multiple pick-ups and multiple drop off locations. The journey type may alternatively indicate that it is a pick-up from an airport or a drop at an airport.
Pick-up address. This indicates an address at which the customer is to be picked up at the beginning of the journey. The address is a natural language address. The address is selected from one of the plurality of addresses stored in a database. The addresses may be stored in the operational database 130 or the historical database 132, or they may be provided by an external address database service, for instance geo.me or qas.co.uk. The addresses each have associated therewith a verified coordinate location expressed in latitude and longitude. Multiple databases may be used (in a hierarchical fashion) for address lookup. The pick-up address may be selected by the customer in any suitable way, with the most appropriate way depending on whether the customer is using the software application on their mobile device, using the web booking service or using an agent in a call centre. If the journey type is an airport pick-up type, the pick-up address indicates the airport and terminal and optionally flight number.
Drop off address. The drop off address again is selected from one of multiple addresses stored in the database and is selected by the customer in any suitable way. If the journey type is an airport drop off type, the pick-up address indicates the airport and terminal and optionally flight number.
Pick-up date and time. This indicates a time and date which the customer requires the journey to start. Alternatively, the date and time may indicate ASAP (as soon as possible), if the customer requires the private hire vehicle at the earliest opportunity.

Optional information regarding the booking includes the following.
Customer's reference. This can be provided for instance as free text or selected from a drop-down menu. If a reference is provided, this information can be included in an account statement against a journey at a later date.
Additional comments. This is free text that provides any potentially relevant information, and may be provided to the driver once the booking has been allocated.

The system 100 comprises a journey cost calculation module 122. The cost calculation module 122 executes software code which determines the price for a requested journey, during the booking process and prior to vehicle allocation. Journey cost calculation is performed at the time of a booking and the result returned to the customer requesting the booking. The resulting cost for the journey is provided before the customer confirms the booking.

The journey cost calculation module 122 uses a number of different ways of calculating the base cost of the journey. The module 122 may set a fixed price for some journeys. These are agreed in advance with a particular account customer for journeys between pre-determined points. The cost calculation module 122 checks whether the booked journey and customer meet the requirements for a fixed price tariff. If the conditions are not met, then another pricing method is used. The cost calculation module 122 may use zonal pricing if a fixed price is not used. Where every point on the journey is within a defined zone, zonal pricing can be used. If neither fixed pricing nor zonal pricing is used, or if the conditions for their application are not met, then the cost calculation module 122 may use an A to B (A-B) pricing method. The A-B method may specify the number of units between points A and B. A unit price depending on the type of vehicle etc. is then used to calculate the price. If there is no A-B record for a particular journey, the crow fly (direct) distance (i.e. the length of a straight line between the pick-up and drop-off locations) is used to calculate the base cost for the journey. This method may use map grid references or alternatively may be based on GPS data, i.e. the latitude and longitude of the pick-up and drop-off points.

The cost calculation module 122 may retrieve all the map and location information needed to make these calculations from the historical database 132. The historical database 132 may store a detailed geospatial model of a particular region, such as a city. As an alternative, or in addition to the methods described above, the cost calculation module 122 may use the real road distance for the journey, which is calculated using the road map from the historical database 132 and a route planning algorithm. Different rates may be used for different parts of a single journey. For example a first per mile rate may be used for the first 10 miles of a journey and a second per mile rate may be used for the rest of the journey. The historical database 132 may also store information regarding speed limits and historical traffic data. This information may also be used by the cost calculation module 122 to calculate an estimated time for the journey. The estimated journey time may then form the basis of the cost calculation.

Other criteria used by the cost calculation module 122 when calculating the price are the type of vehicle (VIP, green, 7-seater etc.) including any special facilities the vehicle has, the method of payment and the date and time of the journey. The cost calculation module 122 may also apply a flat “pick-up fee” for every journey.

The cost calculation module 122 may also determine how much of the fare charged to the customer is passed to the driver. This may be a simple percentage of the total fare or a more complex calculation based on one or more of journey time, distance, waiting time and number of passengers.

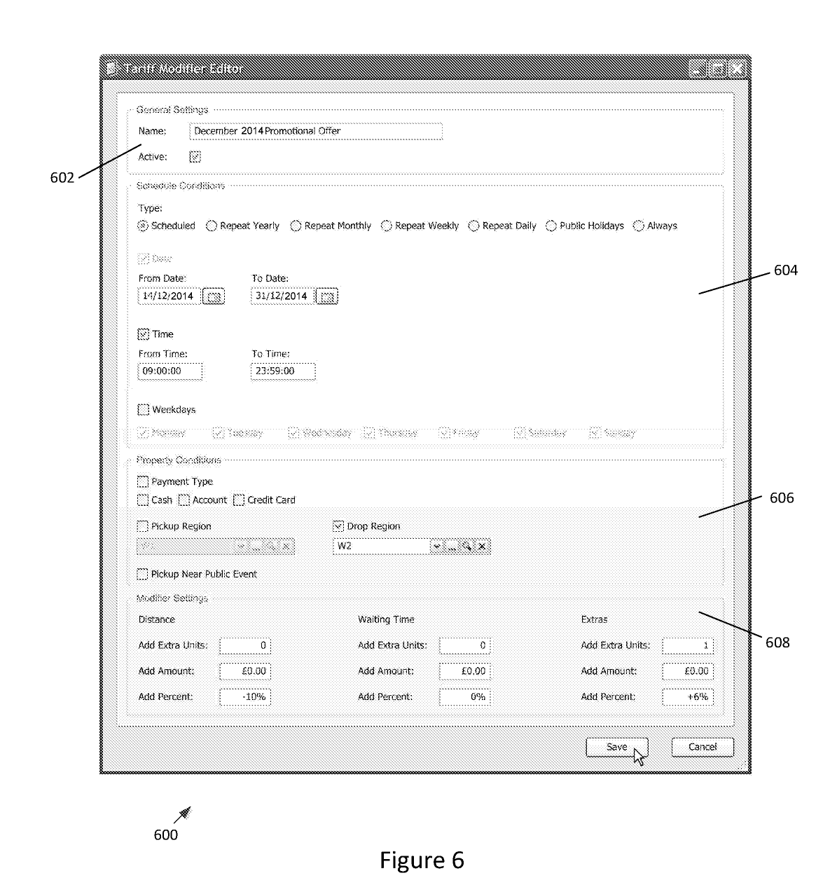

The system 100 also comprises a price modifiers database 123. As will be explained in further detail with reference to FIG. 6, the price modifiers database 123 stores a number of individual “modifiers” which may apply globally, i.e. to all journeys or only to a particular tariff or account. The journey cost calculation module 122 is configured to access the price modifiers database 123 to check whether each modifier applies to a booking when the booking is received.

The allocation function allocates a vehicle and driver to a booking. The allocation function is described in some detail below. In brief, a vehicle and driver are allocated to the booking, and the associated customer, having regard to a number of factors including the pick-up location specified in the booking, the drop off location specified in the booking, the service type specified in the booking, the date and time specified in the booking, the geographical distribution of the vehicles that are managed by the system 100, the demand for vehicles that are managed by the system 100 and information relating to the drivers.

The allocation function is automatic insofar as it does not require any manual involvement once the booking has been made. Once a job has been allocated to a particular driver and a particular vehicle, this is recorded in the operational database 130 with an indication that the journey has not yet been travelled.

The vehicle and driver management function includes a number of features. These include the monitoring of vehicle in terms of distance travelled etc. and ensuring that they provided for mechanical servicing at appropriate times. Drivers are managed also to ensure that documentation relating to private hire vehicle licenses, insurance etc. is in place. Additionally, the function maintains a record of hours worked and jobs performed, along with any other relevant information.

The accounts management function acts to manage information relating to customer's accounts with the operator of the system 100. This includes the maintenance and management of information such as authorised users, credit limits, invoicing requirement etc.

The record keeping function acts to store various information that is created by or observed by the system 100. This information includes information about bookings yet to be fulfilled, which is included in the operational database 1300.

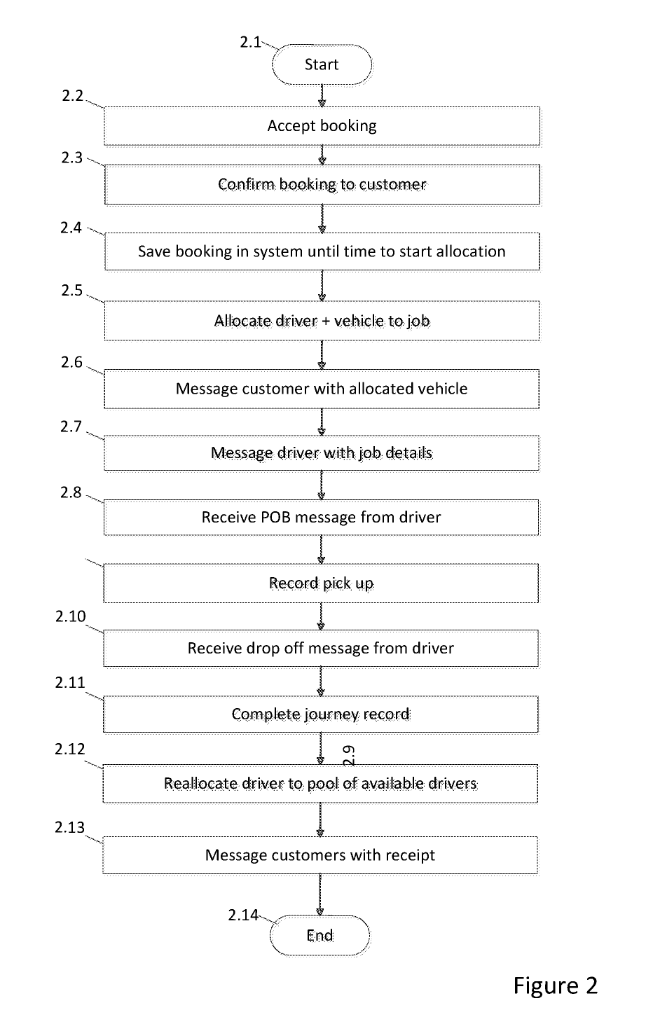

The sequence of steps that are performed by the system during execution of a job will now be described with reference to FIG. 2. This shows execution of a relatively simple job in which there is one pick-up location, one drop off location, no driver reallocation and no variation in the journey. Additionally, journey costing and invoicing are not covered by this Figure.

The operation starts at step 2.1. At step 2.2, a booking is accepted by the system 100. Alternative ways for accepting a booking are described above with reference to FIG. 1a.

At step 2.3, the booking is confirmed to the customer, for instance by email. The message sent to the customer by the system 100 includes a booking reference number and some or all of the information relating to the booking, including the pick-up and drop off locations, the date and time of pick-up etc.

At step 2.4, the system 100 saves the booking until it is time to start allocation. For an ASAP job, allocation may commence straight away. Otherwise, allocation may start a fixed time before the date and time specified for pick-up in the booking information, as is described in more detail below.

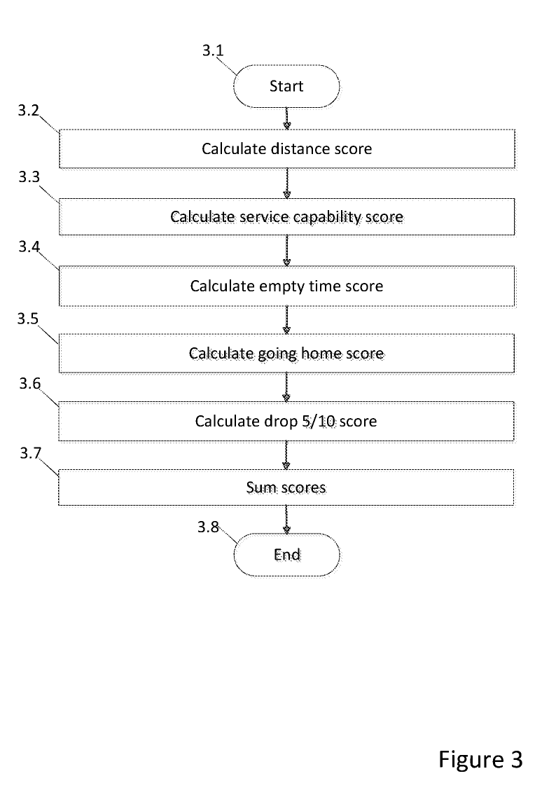

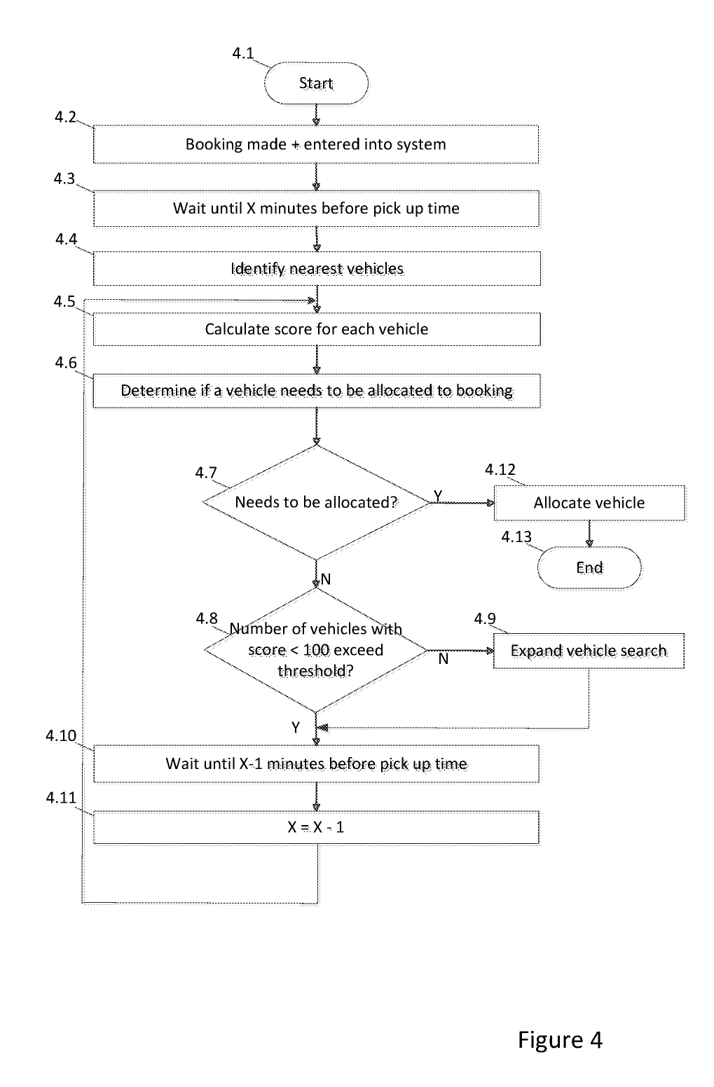

At step 2.5, the system allocates a driver and a vehicle to the job. This is discussed in relation to FIG. 3 and FIG. 4 below. On allocating the vehicle, the status of the vehicle and driver is changed from “Available” to “Allocated”. This prevents the vehicle/driver being allocated to a different job until the status changes to a suitable status.

At step 2.6, the system 100 sends a message to the customer with details of the allocated vehicle. The message includes text such as ‘Your vehicle is on its way’. The message also indicates the job number, which may be the same as the booking number. The message also indicates the identity of the vehicle, so that it can be readily identified by the customer. The identity of the vehicle may be indicated for instance by the registration or license plate that is provided on the vehicle. It may also indicate the make and model of the vehicle, and/or the colour of the vehicle. Additionally, the message includes information by which the customer can contact the driver that has been allocated to the job. For instance, it may include the mobile telephone number of the driver. Providing the mobile telephone number of the driver allows the customer to call the driver with any comments or questions that they may have before the customer is collected by the vehicle. Additionally, the message includes a hyperlink to a webpage at which the location of the vehicle is shown on a map. This allows the customer to identify where the vehicle is at any stage between the vehicle being allocated to the job and the customer being collected by the vehicle.

At step 2.7, the system 100 sends a message to the driver with details of the job. The message includes various pieces of information including the name of the customer. This allows the driver to confirm the customer when the driver meets the customer at the pick-up location. The message also includes the pick-up location and the drop off location. The pick-up location and drop off location may be provided in the message in such a way that they can be extracted by the driver's device 110 and automatically placed into a navigation application that is present on the driver's device 110. This allows the driver to commence the provision by the driver's device 110 of navigation guidance to the pick-up location in response to the driver selecting the pick-up location by way of an input on the driver's device 110. Similarly, after the customer has been collected at the pick-up location, the driver can cause the device 110 to commence providing route guidance to the drop off location by providing a suitable input on the driver's device 110.

The system may comprise a route planning module configured to run a route planning algorithm. The route planning module may access the map and location database 109 in order to calculate a route. The route planning module may also access historical traffic data in the historical database 132 and/or live traffic information in order to more accurately predict the fastest route. Once a driver has indicated that they have picked up a customer, the route planning module may provide route guidance to the driver via the driver's device 110. The route guidance may be in the form of navigation instructions. Having a centralised route planning and guidance providing system avoids the need for the driver to provide their own route guidance device and to keep such a device updated.

At step 2.8, the system 100 receives a POB (passenger on board) message from the driver. This message is transmitted by the driver's device 110 in response to the driver indicating that they have collected the customer from the pick-up location. The option to indicate POB status is provided to the driver once the driver device 110 determines that the vehicle has arrived at the pick-up location, or is within a predetermined radius (e.g. 50m) of the pick-up location and has become stationary. However, the sending of the POB message from the driver's device 110 is not automatic. In this step, the status of the vehicle/driver is changed from “Allocated” to “POB”.

Following receiving the POB message from the driver, the system 100 at step 2.9 records that the customer has been picked up. Next, the system 100 receives a drop off message from the driver at step 2.10. This is message is sent by the device 110 after the driver indicates to the driver's device 110 that the customer has been deposited at the drop off location. The option to indicate that the customer has been dropped off may be provided to the driver upon the driver's device 110 determining that the vehicle has reached the drop off location or is within a predetermined radius (e.g. 50m) of the drop off location and has become stationary. However, the sending of the drop off message from the driver's device 110 is not automatic.

After the drop off message has been received from the driver's device 110 at step 2.11, the system 100 completes a journey record for the journey in the operational database 130 (the record was created during the booking process). The record of the journey stored in the operational database 130 includes the following information. The record includes the pick-up address and the drop off address. The information also includes the pick-up time and date and, if different, the booking time and date. The record also includes the drop off time and date, as detected by the system 100 in response to receiving the drop off message from the driver at step 2.10. The record also includes the cost of the journey, in terms of financial value.

The record also includes the travelled distance, which is not the crow fly (direct) distance between the pick-up and drop off locations but instead is the road distance travelled by the vehicle. The record also includes the journey time, in terms of minutes and seconds. The record also includes vehicle type information that indicates the type of vehicle that performs the journey.

The record also includes the booking information relating to the journey, which may include information about the identity of the customer that made the booking, the time of making the booking, the mode of making the booking (e.g. web, application or call centre) and any other relevant information relating to the booking.

Next, at step 2.12 the driver and vehicle are reallocated to the pool of available drivers. This is achieved by changing the status of the vehicle/driver to “Available” from “POB”.

The customer is then messaged with a receipt for the journey travelled, if required, at step 2.13. Lastly, the operation ends at step 2.14.

A method of scoring a vehicle against a booking will now be described with reference to FIG. 3. The scoring process of FIG. 3 is performed by the job allocation module 105.

The operation starts at step 3.1. In brief, different scores are calculated at steps 3.2 to 3.7, and at step 3.8 the scores are summed together. Clearly, it will be appreciated that the scores may be calculated in any order, and may be calculated wholly or partly in parallel.

At step 3.2, a distance score is calculated. The distance score allows the distance between a vehicle and the pick-up location of the booking to be taken into account when scoring the vehicle against the booking. The distance score is calculated as the distance between the current position of the vehicle and the pick-up address. The distance has the unit of miles, but it may alternatively be kilometres. The distance is calculated as the distance that will need to be travelled by the vehicle to reach the pick-up address, taking into account road layout, one way streets etc. This is known as the road distance. The shortest route from the vehicle to the pick-up address is used for the distance location, even if this is not the quickest route. The route and the road distance thereof are calculated by the system 100 using information from the historical database 132. It is the last recorded position of the vehicle that is used in the distance score calculation.

An administrator or other operator of the system 100 may apply a setting such that the distance score is always zero, in which case the distance between the vehicle and the pick-up location is not taken into account in the score calculation.

At step 3.3, a service compatibility score is calculated. The service compatibility score results in the taking into account of the car type preference that was specified in the booking against the type of the vehicle that is being scored. If the type of vehicle that is being costed is the same type as that is specified in the booking, or is consistent with that type, then the service compatibility score is zero. The service compatibility score takes a positive value if there is incompatibility between the service type of the booking and the type of vehicle that is being costed. In the case of the booking specifying a VIP and the vehicle being costed being a standard vehicle, a penalty of 500 may be provided as the service compatibility score. This penalty helps to ensure that a VIP vehicle will be provided to fulfil the booking if one is available, but if not then a standard car can be provided.

In the case of the booking specifying a standard four passenger vehicle, a penalty score of 50 points is provided for a vehicle that is a seven-seater vehicle. This helps in ensuring that the booking is serviced with a suitable car, but also contributes to avoiding the removal of a large capacity vehicle from the pool of available vehicles unnecessarily.

In the case of the booking being for a standard car and the vehicle type being a VIP car, a penalty score of 100 is provided. Similarly to the situation described in relation to the larger capacity vehicle, this helps to ensure that the booking is satisfied whilst not removing VIP vehicles from the available fleet unnecessarily.

At step 3.4, an empty time score is calculated. The empty time score allows the utilisation of the vehicle (and corresponding driver) to be taken into account in the scoring of the vehicle in relation to the booking.

The empty time score is calculated as the product of −1 and the time (in minutes) since the last job allocated to the car/driver combination was completed and a cost per empty minute. The cost per empty minute is in effect a weighting factor. The weighting factor may be set by an administrator of the system 100. For a vehicle that is in the state POB, the empty time score is zero.

The inclusion of an empty time score in the operation of FIG. 3 helps to provide load balancing of the vehicles, and load balancing of the drivers. Vehicle load balancing helps to even out wear and tear on different vehicles in the fleet on a unit time basis. Load balancing of drivers is useful because it helps to prevent the likelihood of drivers performing too many consecutive jobs with insufficient breaks in between the jobs, and it also helps to reduce the likelihood that drivers will wait for long periods between jobs. Load balancing of drivers, through use of the empty time score in the costing operation, helps to prevent driver fatigue and thus improves safety.

At step 3.5, a going home score is calculated. If the status of the driver is ‘going home’, then a score is calculated. If the driver has some other state, then the going home score is zero.

If the driver's status is ‘going home’, the going home score is calculated as the product of −1 and the number of saved miles and a distance criteria. The saved miles component of the score provides a measure of how much closer to their home the driver would be if they fulfilled this booking. The saved miles component is calculated as the current distance to home (which is the road distance from the current location of the vehicle to the driver's home address) minus the distance between the drop off address and home (which is the road distance from the drop off location of the booking to the driver's home address). The distance criteria provides a weighting, and may be set by an administrator of the system 100.

The effect of the inclusion of the going home score is to increase the likelihood that a job will be allocated to a driver who is on the way to their home (for instance for a lunch break or having finished their shift) if the job would take the driver to a location that is nearer to their home. The magnitude of the score depends on the distance that would be saved, so a score is obtained if the drop off location is relatively closer to the driver's home address.

At step 3.6, a drop 5/10 score is calculated. For drivers that have a ‘drop in 5’ or a ‘drop in 10’ status, the drop 5/10 score has a positive value. For drivers that do not have a ‘drop in 5’ or a ‘drop in 10’ status, that is for drivers that are vacant and not allocated to a booking, the drop 5/10 score is zero. The status of the vehicle is set by the driver through their driver's device 110. In particular, when the driver's device 110 calculates that there are fewer than 10 minutes remaining in the journey to the drop off address, the driver's device 110 provides an option to the user to adopt the ‘drop in 10’ status. If the driver selects this option on the driver's device 110 (when the vehicle is stationary), the ‘drop in 10’ status is entered. Similarly, when the driver's device 110 detects that there are fewer than five minutes remaining in the journey to the drop off location, the driver's device 110 provides an option to allow the driver to select entering the ‘drop in 5’ status.

If the driver of the vehicle has a ‘drop in 5’ status, a score of 20 points is calculated. If the driver has the ‘drop in 10’ status, a score of 30 points is calculated.

The calculation of a drop 5/10 score allows vehicles that have a POB status (that is, they have a job in progress) to be considered for allocation to a booking. However, a penalty is applied to them with the result that they are less favoured than vehicles that are currently empty. This provides protection against the driver arriving late for the booking if there are unexpected delays in the previous journey.

At step 3.7, the scores calculated in steps 3.2 to 3.6 are summed, to provide a total score for the driver/vehicle/booking combination. This score is then used in an allocation process, as will now be described in reference to FIG. 4. The allocation process of FIG. 4 is performed by the job allocation module 105.

Referring to FIG. 4, the operation starts at step 4.1.

At step 4.2, a booking is made and entered onto the system. This corresponds to step 2.2 of FIG. 2.

At step 4.3, the job allocation module 105 waits until X minutes before the pick-up time for the booking. This results in the allocation process being commenced a predetermined time before the pick-up time (on the correct date). For instance, the value of X may be 20, in which case the allocation process starts 20 minutes before the scheduled pick-up time.

At step 4.4, the job allocation module 45 selects the Y vehicles that are nearest to the pick-up location of the booking. The value of Y may for instance be 20 or 30. The vehicles are determined to be nearest if they have shortest crow fly distance between their current location (which is their last reported location) and the location of the pick-up address. The distance is calculated as the straight line distance between the latitude and longitude coordinates of the location of the vehicle and the location corresponding to the pick-up address. The use of crow fly distances in step 4.4 results in an appropriate number of vehicles being selected for possible allocation to the job but without requiring the processing needed to calculate road distances and routes for each of the vehicles. In step 4.4 it is only vehicles that have the status of available, going home, drop in 5 or drop in 10 that can be selected. The result is a pool of candidate vehicles for the booking.

At step 4.5, a score is calculated for the vehicle/booking combination for each of the vehicles that were selected in step 4.4. The score is calculated as described above with reference to FIG. 3. The result is a numerical value that is an indication of the suitability of the vehicle for the booking.

At step 4.6, the job allocation module 105 determines whether a vehicle needs to be allocated to the booking. This involves determining whether there is one vehicle that is the clear best match for the booking or whether there is only one vehicle (or a small number of vehicles, e.g. 2 or 3 vehicles) that would be able to reach the pick-up location on or before the pick-up time.

There are a number of options for implementation of step 4.6, two of which will now be described.

In one alternative, a comparison is made of the scores for the vehicles as calculated in step 4.5. Because of the way the scoring is achieved, a lower numerical value indicates a greater suitability to the booking. As such, the vehicle with the lowest score is the one that is most suitable for the booking. If at step 4.6 it is determined that the vehicle with the lowest score has a score that is much lower than the second lowest score, it can be determined that the vehicle with the lowest score is sufficiently well suited to the booking that it needs to be allocated to the booking.

Alternatively, the determination that the vehicle needs to be allocated to the booking may be made if the time remaining to the pick-up time is the same as or less than a threshold amount more than the expected journey time from the lowest scoring vehicle to the pick-up address. The threshold provides a buffer. The threshold amount may be two minutes for instance. This is particularly advantageous because it results in the determination that a vehicle needs to be allocated only at the time (or perhaps shortly before the time) when the vehicle would need to leave its current location to arrive at the pick-up location in time to collect the customer on time. By making the determination in respect of the lowest scoring vehicle, it is the vehicle that is best suited to the booking that is determined to be required to be allocated to the booking even if that vehicle is not the vehicle that is closest to the pick-up location or has the shortest journey to the pick-up location.

At step 4.7, it is determined whether at step 4.6 it was determined that a vehicle needs to be allocated. If a vehicle does need to be allocated, the vehicle with the lowest score is allocated to the booking at step 4.12 before the operation ends at step 4.13.

If it is not determined that the vehicle needs to be allocated, which occurs when there is not one clear best vehicle for the booking and when there are plural vehicles that would be able to reach the pick-up location in time to meet the booking, the operation proceeds to step 4.8.

The configuration of the job allocation module 105 to allocate a vehicle to the booking at the last minute, or ‘just in time’, unless there is a clear best vehicle, increases the flexibility of allocation of vehicle resources of the fleet. It also contributes to reducing the overall mileage that is travelled by the vehicles of fleet in order to satisfy the bookings that are received by the system 100.

An optional step 4.8 follows step 4.7. Here, it is determined whether the number of vehicles that are reasonable candidates for allocation to the booking is sufficient. In particular, step 4.8 involves determining whether the number of vehicles with a score less than a threshold value (in this example the threshold value is 100) exceeds a threshold number of vehicles (for instance 5 vehicles). If there are insufficient vehicles, at step 4.9 the vehicles search is expanded to include further vehicles in the pool of candidate vehicles for the booking. The further vehicles are added to the vehicles that are identified at step 4.4, and the further vehicles have scores calculated for them in step 4.5 on subsequent performance of that step.

After step 4.9 or after step 4.8 revealing that there are sufficient vehicles, at step 4.10 the job allocation module 105 waits until X−1 minutes before the pick-up time. Once this time has been reached, the value of X is decremented at step 4.11 and the operation returns to step 4.5, where a new score is calculated for each vehicle in the candidate pool of vehicles. The effect of steps 4.10 and 4.11 is that scores are calculated for vehicles in the candidate pool of vehicles once every minute until a vehicle allocated to the booking.

On subsequent performance of step 4.5 in relation to a given booking, a different result may be achieved. In particular, the status and locations of the vehicles in the candidate pool of vehicles may have changed such that there now is one clear best candidate vehicle for allocation to the booking, or that the lowest scoring candidate needs to be allocated now so that they may arrive at the pick-up location in time (because the journey time from the current location of the best scoring vehicle to the pick-up location is the same as or the slightly greater than the time remaining to the pick-up time).

On subsequent execution of step 4.5, vehicles that no longer have one of the relevant statuses (available, drop in 5 or drop in 10) are removed from the candidate pool of vehicles and are not scored. As such, the size of the candidate pool of the vehicles typically reduces on subsequent executions of step 4.5. If the number of potentially suitable vehicles falls too low, this is addressed by action of steps 4.8 and 4.9, where the vehicle search is expanded and the candidate pool is added to.

It will be appreciated from the above that steps 4.5 and 4.6 are repeated until a vehicle is allocated to the booking. The number of times that the steps are repeated depends on the initial value of X, which dictates how long before the pick-up time allocation process begins, and the number of minutes before the pick-up time that the vehicle is allocated to the booking. For bookings in central city locations where there are relatively large number of vehicles, bookings may be allocated only a small number of minutes, for instance 2, 3 or 4 minutes, before pick-up times. For bookings in more remote locations, where there may be relatively few vehicles and a low vehicle density, bookings may be allocated significantly longer before the pick-up time, for instance 12, 15 or 18 minutes before the pick-up time.

For vehicle fleets with relatively low vehicle densities, having regard to the covered geographical area, a higher value of X may be appropriate. Advantageously, the value of X, which indicates the number of minutes prior to the pick-up time that the allocation process begins, may be set by an administrator of the system.

Similarly, the value of Y, which determines the number of vehicles that are identified to for selection in the pool of vehicles at step 4.4 may be set by an administrator of the system 100.

Instead of the database functions being provided by a small number of databases, in the above embodiments the operational database 130 and the driver network database 131, as well as the historical database 132, the functions may be split between a higher number of databases, as shown in the system 100 of FIG. 1b. Reference numerals are retained from FIG. 1a for like elements, and these elements are not described again here to avoid repetition.

In the FIG. 1b system, an accounts database 119 is configured to store the detail of every account held with the operator of the system 100. The record keeping function is provided primarily by a journeys travelled database 108 and a map and locations database 109, as well as other components of the system 100. Each vehicle has a respective record in a vehicle database 121. Each driver has a record in a driver database 120. Pick-up and drop off addresses are selected from one of the plurality of addresses stored in an address database 115. Once a job has been allocated to a particular driver and a particular vehicle, this is recorded in the journeys travelled database 108 along with an indication that the journey has not yet been travelled.

The core system 101, the web booking server 102, the application booking server 103, the job allocation module 105, the driver location monitoring module 106 and the driver's devices server 107 may be provided by a single server or by a system of cooperating servers, for instance arranged in a cluster. Each of the core system 101, the web booking server 102, the application booking server 103, the job allocation module 105, the driver location monitoring module 106 and the driver's devices server 107 includes dedicated software modules that are specific to that component. In the cases of multiple servers being used, each component may include a respective server (or more than one server) or some components may share a server or server system.

In some embodiments, the vehicle resources are autonomous vehicles, also known as driverless vehicles or driverless cars. Where the system 100 comprises autonomous vehicles, each driver device 110 is replaced with an on-board control system, which can be termed an autonomous mode controller. The autonomous mode controller controls the speed and direction of the autonomous vehicle and maintains an accurate record of the unmanned vehicle's location and orientation. Autonomous driving sensors may include any number of devices configured to generate signals that help navigate the vehicle while the vehicle is operating in an autonomous (e.g., driverless) mode. The autonomous vehicle may comprise a number of cameras and other sensors, including LIDAR and/or radar sensors, which feed information about the vehicle's surroundings to the autonomous mode controller. The information includes the position, constitution, orientation and velocity of nearby objects, including other vehicles. The autonomous driving sensors help the vehicle “see” the roadway and the vehicle surroundings and/or negotiate various obstacles while the vehicle is operating in the autonomous mode. The autonomous mode controller may communicate with the core system 101 via the radio network 111 using any suitable protocol.

The autonomous mode controller may be configured to control one or more subsystems while the vehicle is operating in the autonomous mode. Examples of subsystems that may be controlled by the autonomous mode controller may include a brake subsystem, a suspension subsystem, a steering subsystem, and a powertrain subsystem. The autonomous mode controller may control any one or more of these subsystems by outputting signals to control units associated with these subsystems. The autonomous mode controller may control the subsystems based, at least in part, on signals generated by the autonomous driving sensors.

The autonomous vehicles may have on-board route planning modules as part of the autonomous mode controller. Upon the autonomous vehicle receiving information representing a start and end location for a route, the on-board route planning module accesses the map and location database 109 and optionally traffic data in the historical database 132 and/or live traffic information to calculate a best route. The autonomous vehicle may also be given information representing one or more waypoints to travel to between the start and end locations, or a number of waypoints or locations which can be travelled to in any order. The route planning module may then calculate the most efficient route to take to visit each of the locations.

Alternatively, the autonomous vehicle may not have an on-board route planning module and may instead receive route information, i.e. information specifying one or more routes, or navigation instructions from the core system 101.

The autonomous mode controller of each autonomous vehicle may also be pre-programmed to cause the autonomous vehicle to travel to and wait at a particular location when the vehicle does not have particular start and end points or waypoints to travel to. Alternatively, when the autonomous vehicle is not undertaking a specific journey (i.e. when it is idle), the autonomous mode controller may cause the autonomous vehicle to adhere to one of a number of predetermined circuits or routes. The particular predetermined circuit or route chosen by the autonomous mode controller may depend on the location of the vehicle when it becomes idle.

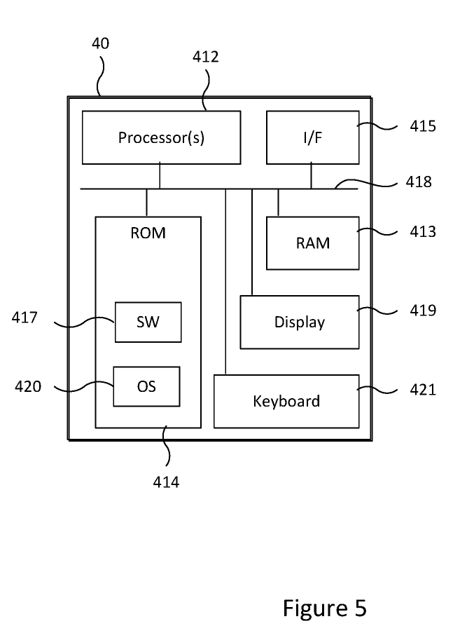

Whether the system 100 includes one or multiple servers, each server includes a number of features as will now be described with reference to FIG. 5. FIG. 5 shows one server 40. If the system 100 comprises plural servers, multiple versions of the FIG. 5 server 40 are connected together.

Each server 40 in the system 100 includes a processor 412. The processor 412 is connected to volatile memory such as RAM 413 by a bus 418. The bus 418 also connects the processor 112 and the RAM 413 to non-volatile memory, such as ROM 414. A communications interface 415 is coupled to the bus 418, and thus also to the processor 412 and the memories 413, 414. The interface 415 is connected to a radio network in any suitable way, for instance via the Internet or a local network. Within the ROM 414 is stored a software application 417, which includes program code that causes the server to perform the functions required of it. An operating system (OS) 420 also is stored in the ROM 414.

An output device such as a display 419 may be provided with the server 40. An input device such as a keyboard 421 may be provided with the server 40. This allows configuration, monitoring and updating by administrators and other users as required. The server 40 may take any suitable form. Generally speaking, the server 40 comprises processing circuitry 412, including one or more processors, and a storage device 414, 413, comprising a single memory unit or a plurality of memory units. The storage device 414, 413 stores computer program instructions that, when loaded into the processing circuitry 412, control the operation of the server 40.

The term ‘memory’ when used in this specification is intended to relate primarily to memory comprising both non-volatile memory and volatile memory unless the context implies otherwise, although the term may also cover one or more volatile memories only, one or more non-volatile memories only, or one or more volatile memories and one or more non-volatile memories. Examples of volatile memory include RAM, DRAM, SDRAM etc. Examples of non-volatile memory include ROM, PROM, EEPROM, flash memory, optical storage, magnetic storage, etc.

Reference to “computer-readable storage medium”, “computer program product”, “tangibly embodied computer program” etc., or a “processor” or “processing circuit” etc. should be understood to encompass not only computers having differing architectures such as single/multi processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

It should be realised that the foregoing embodiments are not to be construed as limiting and that other variations and modifications will be evident to those skilled in the art and are intended to be encompassed by the claims unless expressly excluded by the claim language when taking into account equivalents. Some such alternatives and modifications will now be described.

In the above, journey cost calculation is performed at the time of a booking and the result returned to the customer requesting the booking. Cost calculation may alternatively be performed ahead of the booking being made (for instance on the basis of an agreed tariff), at the end of fulfillment of the booking, or at a later time.

Additionally, the cost scoring of a vehicle against a booking may be performed in any suitable way. Also, cost scoring may be performed only once and the best vehicle allocated at that time, rather than cost scoring being performed until it is decided to allocate a vehicle.

Moreover, the disclosure of the present application should be understood to include any novel features or any novel combination of features either explicitly or implicitly disclosed herein or in any generalisation thereof and during prosecution of the present application or of any application derived therefrom, new claims may be formulated to cover any such features and/or combination of such features.

The basic method of price calculation has been described above with reference to the journey cost calculation module 122 of FIGS. 1a and 1b. This method uses the distance (or a distance measure) as the basis of the cost. According to embodiments of the present invention, after calculating a base cost, the journey cost calculation module 122 then checks to see whether any price modifiers should be applied to the cost before it is sent to the customer. The journey cost calculation module 122 does this by accessing information stored on the price modifiers database 123.

The price modifiers database 123 stores a list of modifier rules, each of which specifies at least one condition under which an adjustment to the base price is to be applied. FIG. 6 shows a screenshot of a graphical user interface (GUI) 600 which is generated by the system 100 for creating and editing these modifier rules. The GUI 600 has a general settings section 602 which specifies a name for the modifier rule and has a tick box indicating whether the rule is currently active or not. This can be used by an administrator to quickly disable a modifier rule without deleting it.

The GUI has a schedule conditions section 604. This section allows an administrator to set when the modifier rule occurs by setting a date or date range and optionally a time range. It can also be specified on what days of the week the rule applies. Which of these options are available depends on how often the rule recurs. The rule may be a one-off occurrence, may apply all the time, or may repeat yearly, monthly, weekly or daily. Alternatively, the rule may apply only on public holidays.

The schedule conditions section 604 allows an administrator to determine the times and dates during which a modification to the standard mileage or area to area rate applies. For example, the standard rate may be £1 per mile. For a particular period, such as from 14 Dec. 2014 to 31 Dec. 2014, the rate is modified to £2 per mile. This functionality allows seasonal rates to be set. Alternatively, the rate may be modified for a more specific period such as between 17:00 on 31 Dec. 2014 to 05:00 on 1 Jan. 2015. This type of modification allows the system to account for expected busy periods in advance. Thus, when a customer makes a booking in advance where the booking begins and/or is expected to end within the specified period, a modified value is used when calculating the price for the journey such that an accurate price is returned to the customer at the time of the booking.

The GUI 600 also allows an administrator to set the days of the week on which a modifier applies. This allows different prices to be applied automatically for the weekend, or on specific weekdays that are known to be busy or less busy. For example an price increase modifier could be applied for periods which are expected to be busy, while a price decrease modifier could be applied for periods which are expected not to be busy.

The GUI 600 has a property conditions section 606. This section allows an administrator to set conditions relating to the pick-up and drop-off locations as well as the method of payment. A pick-up and/or drop-off region can be specified. The pick-up and drop of regions can be selected from a list stored on the map and locations database 119. When a journey booking is received, the region identifier is extracted from the booking information, or if no region identifier is present the address or global position is used by the map and locations database to determine the region. For example, a geospatial model stored in the map and locations database may divide a city or region up into areas. Using London as an example, the city may be divided into areas corresponding to post codes. A discount of 10% could be applied to all journeys between two postcodes both beginning with WC or both beginning with EC and/or between areas WC and EC. The GUI 600 in FIG. 6 shows a modifier being applied for journeys which end in region “W2”.

The property conditions section 606 also has a checkbox for “pickup near public event”. The price modifiers database 123 may store separately a list of future public events and an associated pick-up area. The pick-up area may be anywhere within a predetermined distance of the event location, or alternatively may specify particular locations. If this box is checked, the journey cost calculation module 122 checks the pickup location information in the journey booking against the list of public events for a match.

The property conditions section 606 also allows modification based on the method of payment. Options of “cash”, “account” and “credit card” are available. More than one option may be selected at once. If none of the boxes are checked, then the modifier applies whatever the method of payment. In order to encourage account creation and repeat business, a discount may be applied to bookings which will be paid for using an account.

Price modification based on payment method may be implemented dynamically to adjust prices to cope with increased demand in a particular area or for a particular period. For example, if a particular area becomes very busy, i.e. a lot of bookings are received in a short period of time, then a price increase may be applied for bookings beginning in that area which will be paid for in cash. This price modifier rule may be created automatically by the journey cost calculation module 122 when certain conditions arise and also deleted automatically. It may also however by amended or disabled manually by an administrator. This price increase may be applied for a predetermined period of time, or until the number of bookings per hour drops below a threshold, or until the average customer wait time or late time drops below a predetermined threshold. This modifier can therefore act as a means for prioritising account bookings over cash bookings.

The GUI 600 has a modifier settings section 608. This section details the way in which the price is changed by the modifier rule. In particular, a modification to the distance (mileage) rate can be applied, a modification to the waiting time rate can be applied and/or a modification which is not linked to journey distance or wait time can be applied, termed “Extras”. Each modification may be in terms of a number of units, a percentage or an absolute amount. More than one type of price modifier may be used simultaneously. Depending on the type of base price calculation used by the journey cost calculation module 122, the base price for a journey may be dependent on the distance unit amount multiplied by a price per distance unit value (specified elsewhere). The base price for a journey may also be dependent on the waiting time unit amount multiplied by the total expected waiting time.

The criteria in the schedule conditions section 604, the property conditions section 606 and the modifier settings section 608 may be used in combination to create very specific rules. Thus rules can be tailored for specific clients.

Some further property conditions which are not shown in the GUI 600 of FIG. 6 can also be used to control the price for a journey. In particular, the property conditions section 606 of the modifier rule may allow specific location to be set for the pick-up and drop-off locations, rather than specifying a whole region. This allows only very specific journeys to be subject to the modifier. An additional field may allow journeys over or under a certain mileage to be subject to a modifier. For example, a discount modifier (e.g. −10%) may be applied to all journeys over a given distance, for example 10 miles. The discount may be applied to the whole journey or only to the portion of the journey over the threshold distance. When a booking is made, the real road distance of the journey is calculated. This distance is compared to the distance threshold in the modifier rule and if the threshold is exceeded, then the discount modifier is applied and the discounted price is communicated to the user at the time of the booking. Where such a discount has been applied, the server may also notify the user that they have received the discount.

Alternatively or in addition, the price calculation may be modified on an individual customer or individual account basis. When a customer makes a booking, that customer is identified by the server, for example using their phone number or other log-in details. The server can then check the database of customer details to see if any price modifier rules are associated with that customer. For example, if customer “X” receives a 10% discount on all journeys, there will exist a modifier rule associated with customer X's database entry which applies (in the “Extras” category) a percentage modifier of −10% to the calculated price. The schedule condition for this modifier rule would be “always”. Price modifiers may be applied on an account basis, for example all customers associated with and making a booking via account “Y” may receive a 10% discount.

Price modification based on an individual customer or account basis may be combined with modification based on time and date. For example, the discount for account “Y” may only apply during business hours, e.g. 9 am-5 pm. Price modification based on an individual customer or account basis may be combined with modification based on an individual journey basis. For example, a modifier may apply a discount where account customer “Y” books a journey to go between points “A” and “B”. Points A and B may both be premises owned by account customer “Y” for example.

The class of vehicle also affects the price for the journey. This may be applied as a price per mile increase for executive and luxury vehicles. For particular individuals or particular accounts, a modified price for bookings of executive/luxury cars may be agreed. The modified price determination process may read the “car type” parameter and check for any discounts linked to this parameter.

Drivers may be made aware of the price modifiers which are in operation so that they are able to prioritise high value work. Alternatively, the price modification may be known only to the central system.

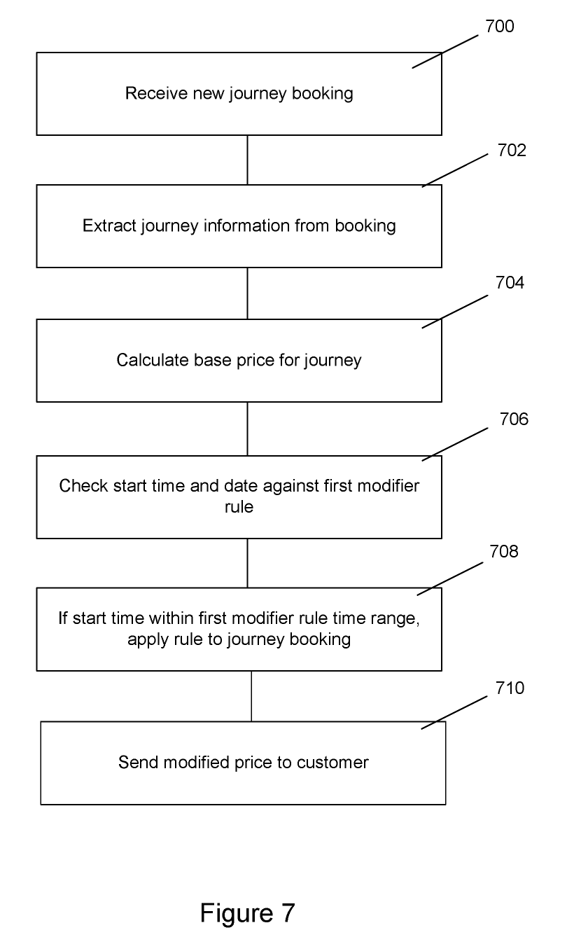

FIG. 7 is a flow chart illustrating exemplary operation of the invention according to some embodiments. At step 700 a new journey booking is received at the system 100.

At step 702, the journey cost calculation module 122 extracts journey information from the booking. This information is at least the customer identity, start time of the journey and the start and end locations of the journey. However, the information may also include an account identifier, the total distance for the journey (or the journey cost calculation module 122 may calculate this), the type of payment that will be used, the pick-up region, the estimated journey time and hence end time for the journey, a tariff identifier (this may be determined by the journey cost calculation module 122 from the other journey details), and the type of vehicle requested.

At step 704, the journey cost calculation module 122 calculates a base price for the journey. This calculation is based on the distance as previously described with respect to FIG. 1 and may also take into account the total estimated waiting time required.

At step 706, the journey cost calculation module 122 checks the extracted start time and date against the first modifier rule. Modifier rules may be “global”, meaning that they apply to every journey, or tariff or account specific. If a modifier rule is account or tariff specific, then the journey cost calculation module 122 first checks whether the extracted account and/or tariff details match those of the modifier rule.

At step 708, if the start time and date of the booking is determined to be within the time/date range specified in the first modifier rule, that rule is applied to the base price calculated in step 704. Optionally, applying the rule may comprise checking the property conditions, if any exist for the rule. The property conditions further limit the applicability of the rule as described above. Thus the booking details may have to meet further criteria (such as payment type and pick-up/drop-off region) before the price modifier is applied.

At step 710, the modified price is sent to the customer. The customer either confirms that they are happy with the price, in which case the booking is completed, or they do not agree to the price in which case the booking is not completed.

The “first modifier rule” may be the modifier rule which has the highest sequence order number. Each price modifier rule stored in the price modifiers database 123 may have an order number representing the order in which the modifier rules should be applied to the base price. Every modifier rule which applies to a particular journey is applied to the base price for that journey according to this order. Thus the journey cost calculation module 122 checks the journey details against the rules in order. In some embodiments the global modifier rules are applied before the account or tariff specific rules. Modifier rules relating to date and time may have a higher priority than other rules. Modifier rules which have a distance or waiting time price modifier may have a higher priority than those which use the “Extras” modifier.

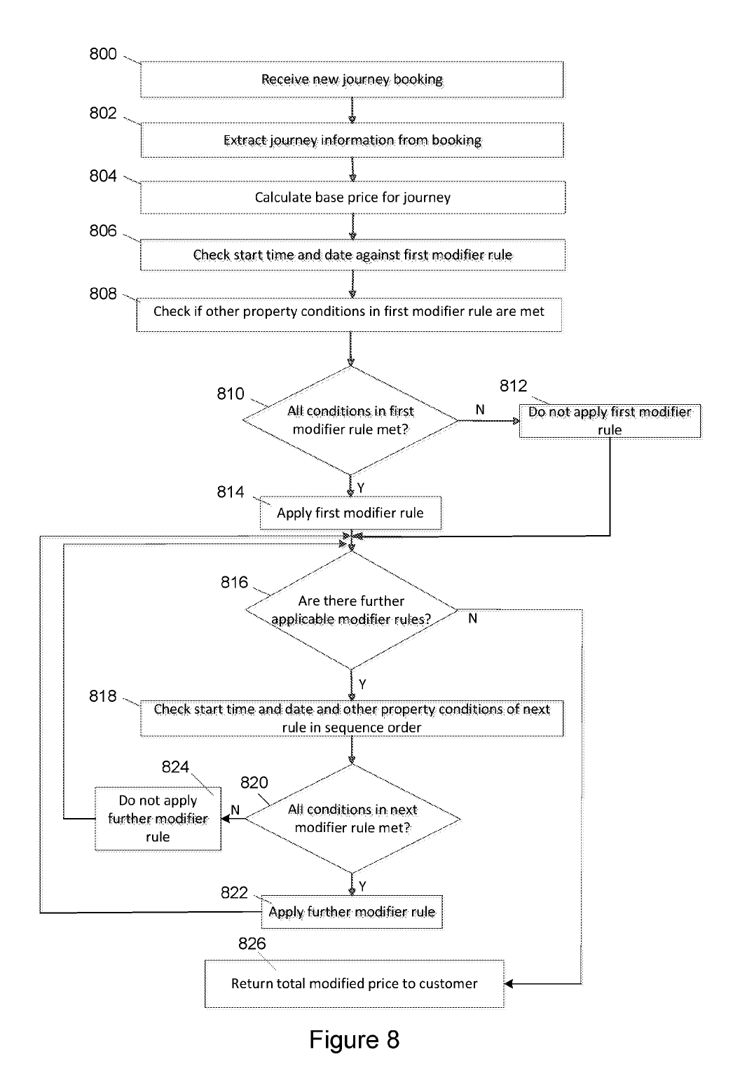

FIG. 8 is a flow chart showing the way in which the journey cost calculation module 122 can apply multiple price modifier rules in sequence order.

Steps 800 to 806 are the same as steps 700 to 706 of FIG. 7. At step 802, the journey cost calculation module 122 extracts journey information from the booking. This information is at least the customer identity, start time of the journey and the start and end locations of the journey. However, in this embodiment, the information also includes one or more of an account identifier, the total distance for the journey (or the journey cost calculation module 122 may calculate this), the type of payment that will be used, the pick-up region, the estimated journey time and hence end time for the journey, a tariff identifier (this may be determined by the journey cost calculation module 122 from the other journey details), and the type of vehicle requested.

At step 804, the journey cost calculation module 122 calculates a base price for the journey. This calculation is based on the distance as previously described with respect to FIG. 1 and may also take into account the total estimated waiting time required.

At step 806, the journey cost calculation module 122 checks the extracted start time and date against the first modifier rule. Modifier rules may be “global”, meaning that they apply to every journey, or tariff or account specific. If a modifier rule is account or tariff specific, then the journey cost calculation module 122 first checks whether the extracted account and/or tariff details match those of the modifier rule.

At step 808, the journey cost calculation module 122 checks the extracted journey details against the property conditions specified in the first modifier rule.

At step 8100, the journey cost calculation module 122 checks whether all of the conditions (date/time and property conditions) specified in the first modifier rule are met by the journey information in the booking. If all of the conditions are not met, then at step 812, the first modifier rule is not applied to the base price. The process then moves to step 816. If at step 810 it is determined that all of the conditions are met, then at step 814 the first modifier rule is applied to the base price as previously described. The process then moves to step 816.

At step 816, the journey cost calculation module 122 checks whether there are any further applicable modifier rules. As previously mentioned, rules may be global or tariff or account specific. The journey cost calculation module 122 may check whether there are further global rules and apply these next, before moving on to any tariff or account specific rules that apply to the particular journey booking received in step 800. As each modifier rule stored in the price modifiers database has a sequence order number, the journey cost calculation module 122 may increment the current order number by 1 and search for a modifier rule having this order number. If no rule is found, it can be determined that the previously applied rule was the last rule applicable to the journey in question.

If it is determined at step 816 that a further modifier rule is applicable to the journey booking, then at step 818 the journey cost calculation module 122 checks whether the start time/date and the other property information specified in the further rule is met by the journey booking details. This step is equivalent to steps 806 and 808 performed on the first modifier rule.

At step 820 the journey cost calculation module 122 checks whether all of the conditions in the further modifier rule are met. This step is equivalent to step 810 performed for the first modifier rule. If all of the conditions are met, then at step 822 the further modifier rule is applied to the base price as previously described. If at step 820 it is determined that all of the conditions are not met, then at step 824 the further modifier rule is not applied to the base price. After either step 822 or 824 are applied, the process returns to step 816, where the journey cost calculation module 122 checks whether there are any further applicable modifier rules. If at any point it is determined by the journey cost calculation module 122 that no further applicable rules exist in the price modifiers database 123, then the process ends at step 826 with the price being sent to the customer including any price modifiers that were applied at steps 814 and/or 822.

1. A method of calculating a price for a vehicle journey, the method comprising:
a vehicle management server receiving a journey booking comprising journey information, the journey information specifying at least a start time, a start location and an end location;
a journey cost calculation module calculating a base price for the journey based on the start and end locations of the journey;
the journey cost calculation module checking whether the start time of the journey booking is within a predetermined time period specified by a first modifier rule; and
if the start time of the journey booking is within the predetermined time period, applying a price adjustment to the calculated base price according to the first modifier rule.

2. A method according to claim 1, further comprising the journey cost calculation module:
checking whether the start location and/or end location of the journey are within a predetermined region specified by the first modifier rule; and
if the start location and/or end location of the journey are within the predetermined region, applying the price adjustment to the calculated base price according to the first modifier rule.

3. A method according to claim 2, wherein the predetermined region is a predefined region of a city.

4. A method according to claim 2, wherein the predetermined region is defined by a predefined proximity to a public event.

5. A method according to claim 1, wherein the journey information specifies a payment type for the booking and further comprising the journey cost calculation module:
checking whether the payment type specified in the journey information meets a payment type condition specified by the first modifier rule; and
if the payment type meets the payment type condition, applying the price adjustment to the calculated base price according to the first modifier rule.

6. A method according to claim 1, wherein the journey information specifies a total journey distance for the booking and further comprising the journey cost calculation module:
checking whether the total journey distance specified in the journey information meets a total journey distance condition specified by the first modifier rule; and
if the total journey distance meets the total journey distance condition, applying the price adjustment to the calculated base price according to the first modifier rule.

7. A method according to claim 1, wherein the journey information specifies a customer account for the booking and further comprising the journey cost calculation module:
checking whether the customer account specified in the journey information meets a customer account condition specified by the first modifier rule; and
if the customer account meets the customer account condition, applying the price adjustment to the calculated base price according to the first modifier rule.

8. A method according to claim 1, wherein the price adjustment comprises one or more percentage adjustments.

9. A method according to claim 1, wherein the price adjustment comprises one or more fixed amount adjustments.

10. A method according to claim 1, wherein the price adjustment comprises one or more unit amount adjustments, wherein the base price for the journey is dependent on the unit amount multiplied by a price per unit value.

11. A method according to claim 1, further comprising the journey cost calculation module searching a price modifiers database for further modifier rules which are applicable to the received journey booking.

12. A method according to claim 11, wherein each modifier rule stored in the price modifiers database has an associated sequence order number and further comprising the journey cost calculation module checking the modifier rules stored in the price modifiers database against the journey information in sequence order.

13. A system for calculating a price for a vehicle journey, the system comprising a vehicle management server and a journey cost calculation module, wherein:
the vehicle management server is configured to receive a journey booking comprising journey information, the journey information specifying at least a start time, a start location and an end location; and
the journey cost calculation module is configured to:
calculate a base price for the journey based on the start and end locations of the journey;
check whether the start time of the journey booking is within a predetermined time period specified by a first modifier rule; and
if the start time of the journey booking is within the predetermined time period, apply a price adjustment to the calculated base price according to the first modifier rule.

14. A system according to claim 13, wherein the journey cost calculation module is further configured to:
check whether the start location and/or end location of the journey are within a predetermined region specified by the first modifier rule; and
if the start location and/or end location of the journey are within the predetermined region, apply the price adjustment to the calculated base price according to the first modifier rule.

15. A system according to claim 14, wherein the predetermined region is a predefined region of a city.

16. (canceled)

17. A system according to claim 13, wherein the journey information specifies a payment type for the booking and wherein the journey cost calculation module is further configured to:
check whether the payment type specified in the journey information meets a payment type condition specified by the first modifier rule; and
if the payment type meets the payment type condition, apply the price adjustment to the calculated base price according to the first modifier rule.

18. A system according to claim 13, wherein the journey information specifies a total journey distance for the booking and wherein the journey cost calculation module is further configured to:
check whether the total journey distance specified in the journey information meets a total journey distance condition specified by the first modifier rule; and
if the total journey distance meets the total journey distance condition, apply the price adjustment to the calculated base price according to the first modifier rule.

19. A system according to claim 13, wherein the journey information specifies a customer account for the booking and wherein the journey cost calculation module is further configured to:
check whether the customer account specified in the journey information meets a customer account condition specified by the first modifier rule; and
if the customer account meets the customer account condition, apply the price adjustment to the calculated base price according to the first modifier rule.

20. A system according to claim 13, wherein the system further comprises a plurality of vehicle resources, wherein the vehicle resources are autonomous vehicles.

21. A non-transitory computer-readable storage medium having stored thereon computer-readable code, which, when executed by computing apparatus, causes the computing apparatus to:
receive a journey booking comprising journey information, the journey information specifying at least a start time, a start location and an end location;
calculate a base price for the journey based on the start and end locations of the journey;
check whether the start time of the journey booking is within a predetermined time period specified by a first modifier rule; and
if the start time of the journey booking is within the predetermined time period, apply a price adjustment to the calculated base price according to the first modifier rule.
